(19) United States
(12) Patent Application Publication
(10) Pub. No.: US 2005/0167175 A1
(43) Pub. Date: Aug. 4, 2005

(54) Cruise control system

(76) Inventors: Kazuyoshi Isaji, Kariya-city (JP); Naohiko Tsuru, Handa-city (JP)

Correspondence Address: HARNESS, DICKEY & PIERCE, P.L.C., P.O. BOX 828, BLOOMFIELD HILLS, MI, 48303, US

(21) Appl. No.: 11/043,010

(22) Filed: Jan. 25, 2005

(30) Foreign Application Priority Data
Feb. 2, 2004 (JP) 2004-025866

(51) Int. Cl. B60K 31/00

(52) U.S. Cl. 180/170

(57) ABSTRACT

A cruise control system includes a speed sensor, an instructor, an accelerator sensor and a speed controller. The speed sensor detects a host vehicle speed. The instructor indicates a start of a cruise control operation. The accelerator sensor detects an operational position of an accelerator pedal at the start of the cruise control operation and a signal position of the accelerator pedal subsequent to the start of the cruise control operation. The speed controller terminates the accelerator pedal from directly controlling an engine output after the start of the cruise control operation and memorizes the operational position of the accelerator pedal. The speed controller also changes the engine output according to a difference between the operational position and the signal position of the accelerator pedal.

### CROSS REFERENCE TO RELATED APPLICATIONS

This application is based upon and claims the benefit of priority of Japanese Patent Application No. 2004-25866, filed on Feb. 2, 2004, the contents of which are incorporated herein by reference.

### FIELD OF THE INVENTION

This invention relates to a cruise control system for changing a cruise speed according to an operation of an accelerator pedal while cruising.

### BACKGROUND OF THE INVENTION

One conventional cruise control system that can change a cruising speed while cruising is disclosed in Japanese patent document JP-A-07-65297. In this system, a bi-directional switch is moveable between a set side and a cancel side. The system begins a cruise control operation at a speed of a host vehicle when the switch is turned to the set side. After setting the cruising speed, a driver of the host vehicle may release his/her foot from an accelerator pedal because operation of the accelerator pedal is no longer required. This conventional system also has a bi-directional speed switch that can control the cruising speed by turning the switch to either of a + (increase) or − (decrease) direction.

In the conventional cruise control system, speed control begins when the switch is turned to the set side. The cruising speed is changed by turning the bi-directional switch to the + or − direction. In other words, there is no need for the driver to operate the accelerator pedal to set and change the cruising speed.

As a result, the driver rests his/her right foot on the floor of the vehicle while cruising and, thus, a reaction time of an emergency braking may take a longer period of time than usual. Therefore, the vehicle may require a longer stopping distance than usual.

Further, the cruising speed can be changed by turning the bi-directional switch to the + or − direction, which may feel odd to the driver because of the difference between a switch speed control and the usual accelerator pedal speed control.

In view of the above-described problem, the object of the present invention is to provide a cruise control system that better equips the driver in case of an emergency stop for stomping a brake pedal and also eases the odd feeling of the speed control switch by diminishing the operational difference between cruise driving and usual driving.

### SUMMARY OF THE INVENTION

To achieve the objective stated above, a cruise control system in accordance with the present invention includes a speed sensor, an instructor, a power controller, an accelerator sensor, an output controller, and a speed controller. The speed sensor detects a host vehicle speed. The instructor indicates a start of a cruise control operation. The power controller controls a driving power of the host vehicle to maintain a cruise speed based on a speed at the start of the cruise control operation. The accelerator sensor detects a position of an accelerator pedal. The output controller overrides the accelerator pedal and controls the engine output after the start of the cruise control operation. The speed controller memorizes an operational position of the accelerator pedal corresponding to the cruise speed and changes the host vehicle speed toward the cruise speed by adjusting the accelerator position toward the operational position when a change in a detected position of the accelerator is one of greater than and less than a predetermined amount.

This cruise control system requires the driver to continue operation of the accelerator pedal even after the start of the cruise control operation. Because this system conserves the same driving operation as a usual driving operation after the start of the cruise control operation, the driver can respond quickly to begin a braking operation in the case of an incident that requires an emergency stop.

However, the cruise speed will not be changed by an operation of the accelerator pedal within a predetermined amount because the accelerator pedal operation that adjusts the engine output is disabled after the cruise control system is operated. Therefore, in the system described above, the accelerator pedal is used only to change the cruise speed while the cruise control system is operating. That is, the cruise speed is changed when the operational position of the accelerator pedal is detected to be changed by an amount that exceeds a predetermined amount from an operational position of a current cruise speed. This helps minimize the differences between operating a cruise control system and performing usual driving and, thus, relieves driver discomfort.

According to another aspect of the present invention, the speed controller increases the host vehicle speed when the accelerator pedal is moved toward an acceleration direction (the pedal is pressed toward the floor of the vehicle) and the detected position of the accelerator pedal is greater than the operational position by the predetermined amount.

According to another aspect of the present invention, the cruise speed controller decreases the host vehicle speed when the accelerator pedal is moved toward a deceleration direction (the pedal is released away from the floor of the vehicle) and the detected position of the accelerator pedal is greater than the operational position by the predetermined amount. In the above-described manner, the host vehicle speed can be increased and decreased by pressing and releasing the accelerator pedal in the same manner as a usual driving operation. Operational feel of the accelerator pedal of this cruise control system thus resembles one in the usual driving operation.

According to yet another aspect of the present invention, the speed controller controls the host vehicle speed in incremental steps. The accelerator pedal operates as a host vehicle speed changing device after the start of a cruise control operation. The speed controller changes the host vehicle speed only when the accelerator pedal is moved more than a predetermined amount from the operational position corresponding to a certain cruise speed. This means that the cruise speed of the host vehicle changes incrementally and, thus, the operational feel of the accelerator pedal is conserved relative to the host vehicle speed when the speed is required to be changed.

According to yet another aspect of the present invention, the power controller preferably maintains a cruise speed when a detected position of the accelerator pedal is kept within the predetermined amount after the cruise speed is changed based on the positional change of the accelerator pedal greater than the predetermined amount.

Other features and advantages of the present invention will be appreciated, as well as methods of operation and the function of the related parts from a study of the following detailed description, appended claims, and drawings, all of which form a part of this application. In the drawings:

### BRIEF DESCRIPTION OF DRAWINGS

FIG. 1 is a block diagram of a cruise control system according to the principles of the present invention;

FIG. 2 is a flowchart of a method of operating the cruise control system of FIG. 1; and

FIG. 3 is a graph illustrating a relationship between the operation of an accelerator pedal of a vehicle including the cruise control system of FIG. 1 and a cruise speed.

### DETAILED DESCRIPTION OF THE PREFERRED EMBODIMENTS

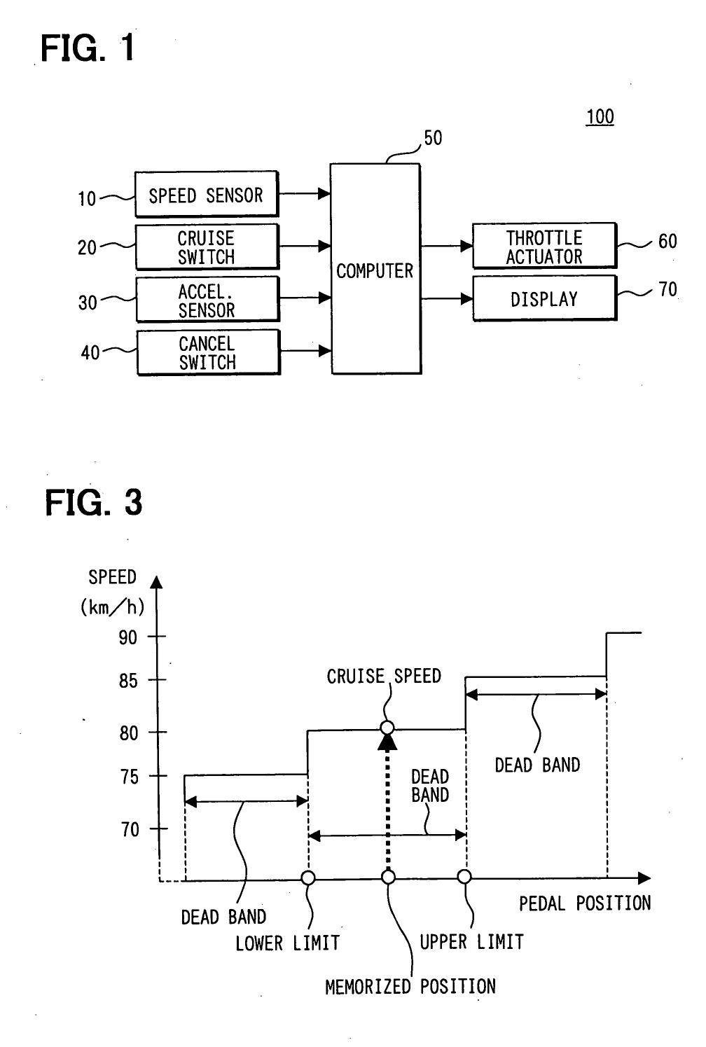

Each of the preferred embodiments of the present invention will be described with reference to the drawings. FIG. 1 shows a block diagram of a cruise control system 100 according to an embodiment of the present invention. The cruise control system 100 is mounted on a vehicle driven by a gasoline combustion engine and can change the cruise speed according to an operation of an accelerator pedal, as well as, stably maintain a cruise speed of the host vehicle. The details of the cruise control system are described in the following.

The cruise control system 100 has a computer 50 as a main component. The computer 50 has a well-known structure that includes a CPU, a ROM, and a RAM. The CPU executes various calculations to control the cruise control system of this embodiment. The ROM stores programs for the calculations and various other items of data required by the computer 50. The RAM temporarily stores information required for the calculations or other processes conducted by the computer 50.

The cruise control system 100 further includes a speed sensor 10, a cruise switch 20, an accelerator sensor 30, and a cancel switch 40 in data communication with the computer 50, as shown in FIG. 1. The speed sensor 10 is disposed in close proximity to an axle of a tire to detect a revolution speed of the tire. The cruise switch 20 issues a start signal to begin the cruise control operation. The accelerator sensor 30 detects a direction and magnitude of the accelerator operation by a driver. The cancel switch 40 issues a cancel signal to stop the cruise control operation. The various signals from the sensors and the switch are directed to the computer 50 as input.

The cruise control system 100 further includes a throttle actuator 60 and a display 70 in data communication with the computer 50. The throttle actuator 60 adjusts the valve opening by controlling a throttle valve in an intake manifold of the engine. The display 70 displays an abnormality of the various sensors and the cruise speed. These devices are connected to the computer 50 and are operated by a control signal from the computer 50.

The computer 50 outputs the control signal to the throttle actuator 60 based on an amount of operation of the accelerator pedal detected by the accelerator sensor 30 when the cruise control system 100 is not in operation. Therefore, the engine output is controlled based on the operation of the accelerator pedal. However, the computer 50 disables the throttle control based on the operation of the accelerator pedal and outputs a control signal based on a difference between an actual speed of the host vehicle and the cruise speed.

The cruise control system with the operational scheme described above in this embodiment starts the cruise control operation of controlling driving power of the vehicle by adjusting the throttle valve with a speed memorized as a cruise speed when the start of the operation is indicated by the cruise switch 20.

In the present embodiment, the operation of the accelerator pedal is continued by the driver even after the start of the cruise control operation. This scheme of operation, in which the driver continues operating of the accelerator pedal while the cruise control system is working, resembles that of a usual driving operation and, thus, accommodates an emergency stop operation in a quick and natural manner.

However, it should be noted that the accelerator pedal operation by the driver does not directly control the engine output when the cruise control system is in operation. The accelerator pedal is only used for providing an instruction to change the cruise speed during the cruise control operation. In concrete terms, the cruise speed is maintained when the operational position of the accelerator pedal is kept within a predetermined range based on the current position corresponding to the current cruise speed. The cruise speed, on the other hand, is changed according to the amount and the direction of the accelerator pedal operation when the operational position of the accelerator pedal, as an indicator of the driver's intention, exceeds the predetermined range.

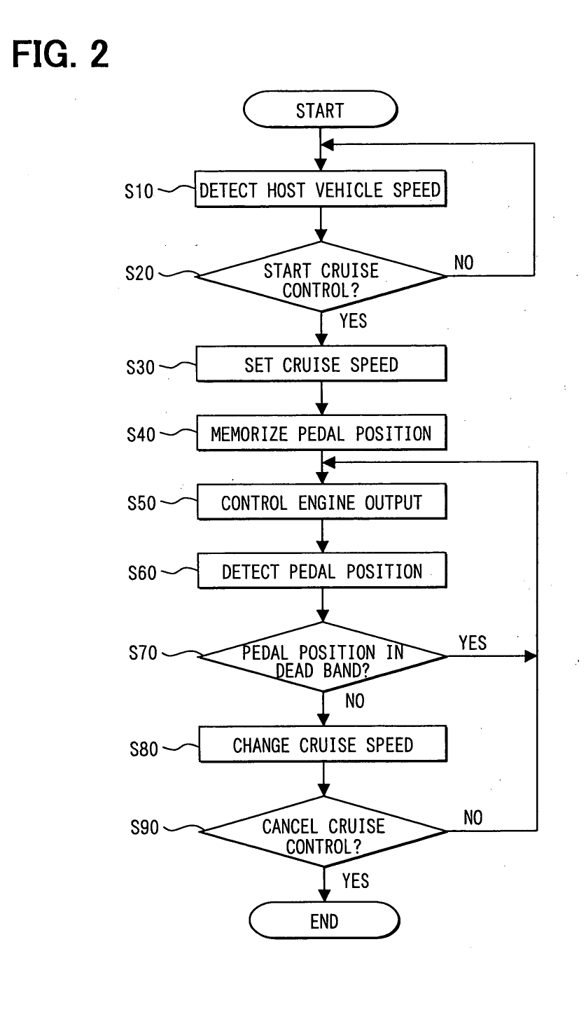

Next, the operation of the cruise control system in this embodiment is described in a more concrete manner based on the flowchart shown in FIG. 2.

In step S10 of FIG. 2, the speed of the host vehicle is detected based on the signal from the speed sensor 10. In step S20, it is determined whether an instruction to start the cruise control operation has been received. That is, it is determined whether or not the driver has operated the cruise switch 20 to issue a start signal when he/she intends to start the cruise control operation. If the signal is determined to have not been issued (Step S20: NO), the process returns to step S10 to continue detecting the host vehicle speed.

If the signal is determined to have issued (Step S20: YES), the process proceeds to step S30. In step S30, the detected speed in step S10 is set as the cruise speed. In step S40, the operational position of the accelerator pedal corresponding to the cruise speed is memorized. This position is used as a standard position to determine the necessity of change of the cruise speed. Change of the cruise speed is described later in detail.

In step S50, the engine output is controlled by a control signal sent to the throttle actuator 60 to maintain the cruise speed of the host vehicle. This control enables cruise control of the host vehicle.

In step S60, a direction and magnitude of a change in the position of the accelerator pedal, hereinafter referred to as an operational position change, is detected based on the signal from the accelerator sensor 30. In step S70, it is determined whether the operational position change is within the range of a dead band. The dead band is explained in the following.

The position of the accelerator pedal seems to change slightly even when the driver intends to maintain a static position. This indicates that the cruise speed should be maintained when a positional change of the accelerator pedal is small.

In the present embodiment, the dead band is defined as a range of positions of the accelerator pedal relative to the operational position. The cruise speed is maintained when a change in the position of the accelerator pedal moves the accelerator to a position that is within the dead band. This dead band is used to determine whether the operational position change of the accelerator pedal is either an indication to change the cruise speed. According to this scheme, the cruise speed of the cruise control system can either be changed or maintained based on the driver's intention.

FIG. 3 shows an example in which an operational position of the accelerator pedal is memorized when the cruise speed is set at 80 km/h. As shown in FIG. 3, the dead band is defined as an upper limit and a lower limit by adding/subtracting a predetermined amount of positional change from the memorized operational position of the accelerator pedal.

Referring back to FIG. 2, in step S70, the driver's intention is regarded as ‘maintaining’ when the operational position change of the accelerator is determined to be within the dead band. In this case, the cruise speed is maintained, the process returns to step S50, and the engine output control is maintained based on the current cruise speed.

Alternatively, however, the driver's intention is regarded as ‘changing’ when the operational position change is determined as exceeding the dead band in Step S70. In this case, the process proceeds to step S80 and the cruise speed is changed based on the direction and magnitude of the positional change of the accelerator pedal. In concrete terms, the cruise speed is incrementally increased to 85 km/h, as shown in FIG. 3, when the operational change positions the accelerator pedal above the upper limit of the dead band and is incrementally decreased to 75 km/h when the operational change positions the accelerator pedal below the lower limit of the dead band.

The relationship between the operational change of the accelerator pedal position and the cruise speed is kept unchanged as in the normal driving operation in terms of acceleration when the cruise speed is incrementally changed upon detecting an operational change of the accelerator pedal position that falls beyond an upper limit or a lower limit of the dead band. According to this scheme of operation, the cruise control system relieves discomfort of the accelerator pedal operation when cruise speed is changed.

That is, the cruise speed is changed only when the positional change of the accelerator pedal exceeds the limits of the dead band. The cruise speed is, thus, incrementally changed according to the positional change of the accelerator pedal.

However, it is important to note that a rapid increase/decrease of the host vehicle speed would cause discomfort to the occupant of the vehicle. Thus, the change rate of the cruise speed is preferably limited. That is, a change of the cruise speed is limited by defining a maximum acceleration/deceleration of the cruise speed. Thus, the incremental changing of the speed is conducted while controlling the throttle valve opening. In this manner, a rapid increase/decrease of the vehicle speed is prevented and discomfort during speed change is suppressed.

After changing the cruise speed, the new cruise speed is maintained while the operational change of the accelerator pedal position falls within the dead band. However, the cruise speed exceeds a controllable range (e.g. between 50 mph and 150 mph, depending on the traffic regulations) if the operational change of the accelerator pedal position further increases/decreases. In this case, the cruise control operation terminates regarding the accelerator pedal operation by the driver as a cancel (termination) instruction of the cruise control.

After changing the cruise speed in step S80, the process proceeds to step S90 and it is determined whether to continue or cease the cruise control operation. The cruise control operation terminates when the operational change of the accelerator pedal position exceeds the controlling range of the cruise speed or when the cancel switch is operated. When the process is determined to continue (step S90: NO), the process returns to step S50 and the cruise control operation is continued based on the newly maintained cruise speed.

In the present embodiment described above, the accelerator pedal operation during the cruise control operation makes the operational environment of the cruise control system resemble that of a usual driving operation environment. A quick response can be expected in case of an emergency stop. Further, discomfort in changing the cruise speed is relieved because the cruise speed can be changed by the accelerator pedal operation.

While the invention has been particularly shown and described with reference to the preferred embodiment thereof, it will be understood by those skilled in the art that various changes in form and details may be made without departing from the spirit and scope of the invention.

For example, while the engine output is controlled by controlling the opening of the throttle valve by the throttle actuator 60 in the embodiment described above, the vehicle speed may be maintained by controlling a brake or a transmission.

Furthermore, while the embodiment disclosed herein describes a cruise control system maintaining a cruise speed, it should be appreciated that the present invention may be applied to a cruise control system with an inter-vehicle distance control function that switches a cruise control and a distance control based on the existence of a preceding vehicle. In this case, the accelerator pedal operation may control the cruise speed during the cruise control operation and may control the inter-vehicle distance during the distance control operation. Therefore, the inter-vehicle distance, as opposed to the host vehicle speed, may be controlled incrementally when the operational change of the accelerator pedal position exceeds the dead band.

1. A cruise control system comprising:
a speed sensor that detects a host vehicle speed;
an instructor that indicates a start of a cruise control operation;
a power controller that controls a driving power of the host vehicle to maintain a cruise speed based on a speed detected at the start of the cruise control operation;
an accelerator sensor that detects a position of an accelerator pedal;
an output controller that overrides the accelerator pedal and controls the engine output after the start of the cruise control operation; and
a speed controller that memorizes an operational position of the accelerator pedal corresponding to a current host vehicle speed and changes the speed according to the operational change of the accelerator pedal position when a detected positional change of the accelerator pedal is greater than a predetermined amount.

2. The cruise control system of claim 1, wherein the speed controller increases the host vehicle speed when the detected position of the accelerator pedal is greater than the operational position by at least the predetermined amount.

3. The cruise control system of claim 1, wherein the speed controller decreases the host vehicle speed when the detected position of the accelerator pedal is less than the operational position by at least the predetermined amount.

4. The cruise control system of claim 2, wherein the speed controller incrementally adjusts the host vehicle speed.

5. The cruise control system of any one of claims 1, wherein the power controller keeps a host vehicle speed when a detected position of the accelerator pedal is kept within the predetermined range after the host vehicle speed is changed based on the operational change of the accelerator pedal position by the amount greater than the predetermined amount.

6. A cruise control system comprising:
a speed sensor that detects a host vehicle speed;
an instructor that indicates a start of a cruise control operation;
an accelerator sensor that detects an operational position of an accelerator pedal at the start of the cruise control operation and a signal position of the accelerator pedal subsequent to the start of the cruise control operation;
a terminator that terminates the accelerator pedal from directly controlling an engine output after the start of the cruise control operation; and
a speed controller that memorizes the operational position of the accelerator pedal and changes the engine output according to a difference between the operational position and the signal position of the accelerator pedal.

7. The cruise control system of claim 6, wherein the speed controller increases the engine output to incrementally increase the host vehicle speed when the signal position of the accelerator pedal is greater than the operational position by more than a predetermined amount.

8. The cruise control system of claim 6, wherein the speed controller decreases the engine output to incrementally decrease the host vehicle speed when the signal position of the accelerator pedal is less than the operational position by more than a predetermined amount.

9. A method of controlling vehicle speed, comprising:
detecting a host vehicle speed;
instructing a start of a cruise control operation;
detecting an operational position of an accelerator pedal at the start of the cruise control operation;
detecting a signal position of the accelerator pedal subsequent to the start of the cruise control operation;
preventing the accelerator pedal from directly controlling an engine output after the start of the cruise control operation; and
changing the engine output according to a difference between the operational position and the signal position of the accelerator pedal.

10. The method of claim 9, wherein changing the engine output includes increasing the engine output to incrementally increase the host vehicle speed when the signal position is greater than the operational position of the accelerator pedal by at least a predetermined amount.

11. The method of claim 9, wherein changing the engine output includes decreasing the engine output to incrementally decrease the host vehicle speed when the signal position is less than the operational position of the accelerator pedal by at least the predetermined amount.
